(19) United States
(12) Patent Application Publication
(10) Pub. No.: US 2004/0021367 A1
(43) Pub. Date: Feb. 5, 2004

(54) Rim with decorative cover

(76) Inventors: Gabriele Rumi, Palazzolo (IT); Maria Clara Manara, Sull'Oglio (IT); Allessandra Rumi, Palazzolo Sull'Oglio (IT); Stefano Rumi, Coccaglio (IT)

Correspondence Address: MUSERLIAN, LUCAS AND MERCANTI, LLP, 475 PARK AVENUE SOUTH, NEW YORK, NY, 10016, US

(21) Appl. No.: 10/203,084

(22) PCT Filed: Oct. 16, 2001
(86) PCT No.: PCT/IT01/00523

(51) Int. Cl. B60B 21/00

(52) U.S. Cl. 301/95.101

(57) ABSTRACT

A rim is decorated by a cover applied at the canal E, i.e. the cylindrical portion extending substantially axially between the crown S, where the spokes extending radially from the hub end, and the radially extending external peripheral flange F. The cover in turn consists of a cylindrical portion K externally ending with a radial flange L, and the connection between said elements is provided by a snap-in coupling achieved by forming on the edge of the flange L of the cover an elastically deformable shaped end M which fits into a corresponding groove H formed on the external face of the flange F of the rim.

The present invention relates to vehicle rims, and in particular to a rim provided with a decorative cover.

It is known that decorative covers are widely used to improve the aesthetic appearance of vehicle wheels, a typical example being the cover applied to alloy rims at the canal. This term is commonly used with reference to the cylindrical portion extending substantially axially between the crown, where the spokes extending radially from the hub end, and the radially extending peripheral flange on the back of which there is formed one of the engagement seats of the tire beads.

This type of cover is presently applied to the rim by bonding or by providing the cover with a shaped edge extending beyond the external edge of said peripheral flange so as to engage on the back thereof. Both these solutions have drawbacks.

The application by bonding does not provide an absolute guarantee of endurance in time, in particular taking into account the considerable temperature range and mechanical stress (blows, vibrations, etc.) which the rim undergoes. Moreover the bonding is generally a longer and more complicated operation with respect to a mechanical coupling in that it may involve problems of staining the rim, may require a heat treatment and/or waiting to achieve a grip sufficient to handle the rim, and so on.

On the other hand, shaping the cover to couple it on the back of the flange requires a more complicated and therefore expensive mechanical working and actually binds the cover to the specific rim for which it is designed. In other words, if different rim models have different profiles of the peripheral flange, also the shaped edge of the cover must be accordingly changed.

Therefore the object of the present invention is to provide a rim and cover assembly which overcomes the above-mentioned drawbacks.

This object is achieved by means of an assembly wherein the cover is applied to the rim through a snap-in coupling, achieved between a shaped edge of the cover and a corresponding groove formed on the front of the peripheral flange close to its external edge.

A first main advantage of the present coupling system is that of requiring a very simple and quick, and therefore cheap, operation which does not imply substantial modifications of the rim structure nor complicated working of the cover.

A second advantage comes from the fact that a same cover can be applied even to rims with different back profile of the peripheral flange as long the position and/or shape of the coupling groove is not changed.

These and other advantages and characteristics of the rim and cover assembly according to the present invention will be clear to those skilled in the art from the following detailed description of an embodiment thereof, with reference to the annexed drawings wherein:

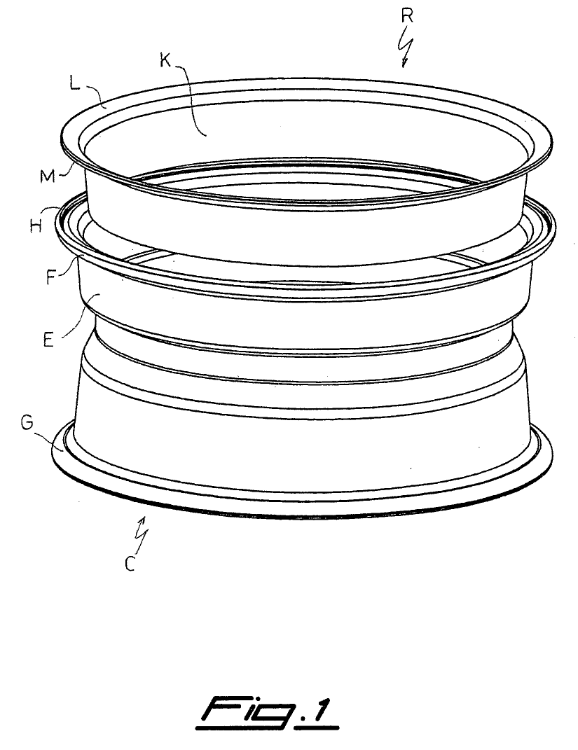

FIG. 1 is a perspective view showing the cover positioned for introduction in the rim;

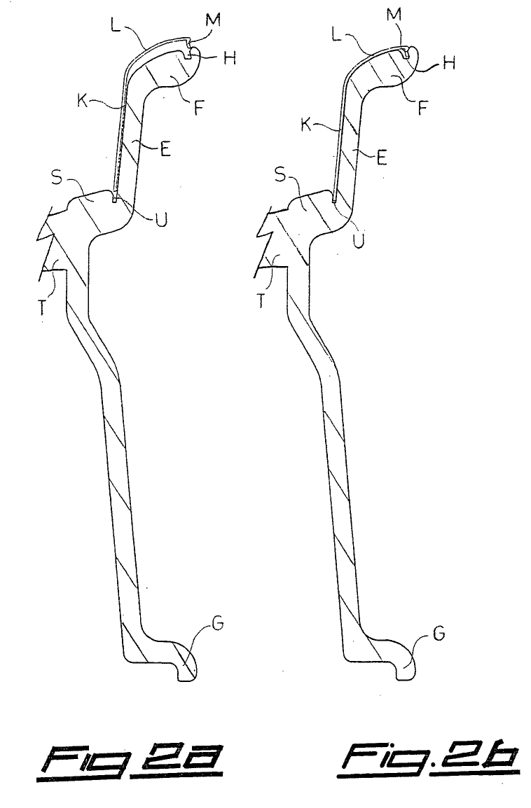

FIGS. 2a and 2b are partial sectional views along an axial plane showing the mounting of the cover onto the rim; and

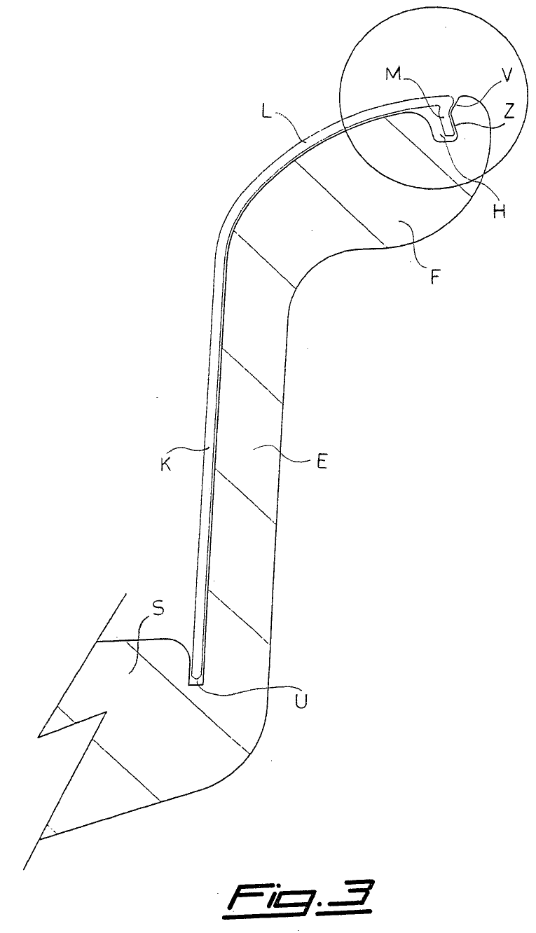

FIG. 3 is a partial enlargement of FIG. 2 showing the details of the snap-in coupling which achieves the connection.

With reference to said figures, there is seen that a rim C according to the invention conventionally includes a central hub from which a plurality of spokes T radially branch off and end into a crown S. A canal E extends in a substantially axial direction from crown S and externally ends with a peripheral flange F, extending in a substantially radial direction, which together with the opposite internal flange G forms the seats for securing the tire.

Cover C in turn conventionally consists of a substantially cylindrical portion K externally ending with a radial flange L, these elements being designed to copy the shape and size of the corresponding elements E, F of rim C.

It should be noted that the orientation internal/external is referred to the position of the wheel mounted on the vehicle and obviously the axis of the rim and of the cover coincides with the axis of rotation of the wheel.

The novel aspect of the present invention is the snap-in coupling achieved by forming on the edge of flange L of cover R a shaped end M, elastically deformable and extending axially inward, which fits into a corresponding groove H formed on the external face of flange F of rim C.

In the enlarged view of FIG. 3 there is illustrated in particular an embodiment of said coupling wherein groove H has a profile in which the radially external side has a first draft segment V, forming a flaring, and a second restraint segment Z, with opposite inclination, which combine to form an undercut in which the cover end M engages.

It should be noted that although in the embodiment above groove H is formed close to the external edge of flange F in order to assure a complete aesthetic covering thereof, it would also be possible to form groove H at a radially more internal position consequently shortening the cover flange L.

In order to guarantee a higher strength of the coupling, a slot U can be formed at the base of canal E, i.e. between the latter and crown S, to receive the internal end of cover R. Furthermore, it is also possible to arrange a layer of adhesive on the radially internal surface of canal E and flange F to achieve a wider connection, although the locking between rim C and cover R is always achieved by the above-described snap-in coupling.

In the light of the above it is clear that the coupling between the two said elements is carried out through a simple pressing operation schematically illustrated in FIGS. 2a, 2b. In practice, it is sufficient to introduce cover R into the rim canal E until its shaped edge M abuts on flaring V of groove H which has a lightly smaller diameter. At this point an axial push on cover R causes the elastic deformation in a radially internal direction of edge M which follows the draft segment of flaring V and fits into groove H by snap-locking along the restraint segment Z.

It is clear that the above-described and illustrated embodiment of the rim and cover assembly according to the invention is just an example susceptible of various modifications. In particular, the snap-in coupling may be achieved also with differently shaped elements, for example by forming the draft segment V and the restraint segment Z along the radially internal profile of groove H rather than on the external profile as described above, with a consequent modification of the shape of the cover edge M.

1. A rim (C) and cover (R) assembly, in which the rim (C) includes a substantially axial canal (E) externally ending with a substantially radial flange (F) and the cover (R) includes a substantially cylindrical portion (K) externally ending with a substantially radial flange (L), said elements being shaped and sized for introducing the cover (R) into the rim (C) for covering said canal (E), characterized in that the connection between said elements is provided by a snap-in coupling achieved by forming on the edge of said flange (L) of the cover (R) an elastically deformable shaped end (M) suitable to fit into a corresponding groove (H) formed on the external face of said flange (F) of the rim (C).

2. A rim (C) and cover (R) assembly according to claim 1, characterized in that the groove (H) is formed close to the external edge of the flange (F).

3. A rim (C) and cover (R) assembly according to claim 1 or 2, characterized in that the groove (H) has a profile in which at least one side consists of a first draft segment (V), forming a flaring, and of a second restraint segment (Z), with inclination opposite with respect to said draft segment (V), said segments (V, Z) combining to form an undercut in which the end (M) of the cover (R) engages.

4. A rim (C) and cover (R) assembly according to one or more of the preceding claims, characterized in that the shaped end (M) of the cover (R) extends axially inward.

5. A rim (C) and cover (R) assembly according to one or more of the preceding claims, characterized in that a slot (U) is formed at the base of the canal (E) to receive the internal end of the cover (R).

6. A rim (C) and cover (R) assembly according to one or more of the preceding claims, characterized in that between the cover (R) and the rim (C) there is provided a layer of adhesive.
